(19) United States
(12) Patent Application Publication
(10) Pub. No.: US 2021/0405197 A1
(43) Pub. Date: Dec. 30, 2021

(54) GLOBAL LOCALIZATION APPARATUS AND METHOD IN DYNAMIC ENVIRONMENTS USING 3D LiDAR SCANNER

(71) Applicant: ELECTRONICS AND TELECOMMUNICATIONS RESEARCH INSTITUTE, Daejeon (KR)

(72) Inventor: Yu-Cheol LEE, Daejeon (KR)

(21) Appl. No.: 17/357,509

(22) Filed: Jun. 24, 2021

(30) Foreign Application Priority Data
Jun. 25, 2020 (KR) 10-2020-0077699
Aug. 26, 2020 (KR) 10-2020-0108030

(51) Int. Cl. G01S 17/89; G01S 17/93; G01S 17/04; G01S 7/48; G01S 7/481

(52) U.S. Cl. CPC G01S 17/89; G01S 17/93; G06K 9/0063; G01S 7/4808; G01S 7/4817; G01S 17/04

(57) ABSTRACT

Disclosed herein are an apparatus and method for global localization for a dynamic environment using a 3D LiDAR scanner. The method may include generating a 2D grid map from 3D point cloud data acquired using the 3D LiDAR scanner, searching for the 2D global position of a vehicle on the 2D grid map using data acquired from the 3D LiDAR scanner, and mapping the 2D global position to a 6-DOF position in the 3D space.

### CROSS REFERENCE TO RELATED APPLICATIONS

This application claims the benefit of Korean Patent Application No. 10-2020-0077699, filed Jun. 25, 2020, and No. 10-2020-0108030, filed Aug. 26, 2020, which are hereby incorporated by reference in their entireties into this application.

### BACKGROUND OF THE INVENTION

### 1. Technical Field

The present invention relates to global localization technology through which the 6-degrees-of-freedom (6-DOF) position of a vehicle can be estimated using a 3-dimensional (3D) Light Detection and Ranging (LiDAR) scanner.

### 2. Description of the Related Art

These days, various kinds of vehicles, such as robots, automated guided vehicles (AGVs), forklifts, and the like, serve to carry loads in a warehouse, perform tasks in dangerous places, harvest farm crops, and the like while freely traveling in the space, thereby replacing humans in many application fields. This is thanks to the development of mapping technology for recognizing the structure and state of the space around vehicles and localization technology for estimating the current positions of the vehicles, among technologies for the vehicle navigation.

For outdoor environments, mapping and localization technology is significantly advanced with the improvement of the accuracy of global positioning systems (GPS). As the importance of GPS is emphasized, Galileo in Europe, GLONASS in Russia, and the like have been developed and released to the public domain in many countries, as well as in the U.S., and many new industries related to the autonomous navigation, such as unmanned vehicles, agricultural tractors, urban delivery robots, and the like are growing. Also, even at a location at which a GPS is temporarily inaccessible, accurate localization is realized using an acceleration sensor and a gyroscope together.

However, it is difficult to use a GPS indoors due to the structure thereof, and various sensors and methods are used in order to develop mapping and localization technology for replacing GPS. Indoor mapping and localization technology may be classified into technology based on artificial markers and technology based on natural markers depending on whether a special device is installed in the vicinity in which a vehicle is driving.

The technology based on artificial markers is a method for performing mapping and localization using reflectors, RFID devices, image texture, beacons, and the like. The technology based on natural markers performs mapping and localization using only the images and structural information of objects in the surrounding environment. The technology based on artificial markers and the technology based on natural markers may be selectively used depending on the application field.

First, mapping and localization technology based on natural markers may be implemented at low cost because there is no need to provide or install any special device or equipment nearby. A representative method based on natural markers is a method in which surrounding environment structure information acquired from a distance measurement sensor or an object texture acquired from an image sensor is used as feature points. However, this technology has low reliability in a dynamic environment in which the positions of objects frequently change or in an environment in which it is difficult to define feature points using only natural markers. Accordingly, this technology cannot be widely used in various application fields.

On the other hand, technology based on artificial markers has high technical reliability because devices specially designed for mapping and localization are used. This technology is utilized to application fields that require high reliability, and is often used at industrial sites where there is little limitation with regard to expense. However, because it is necessary to provide equipment related to artificial markers and because additional expense for managing the artificial markers is incurred, it is not widely used in the personal sector.

A representative method that uses technology based on natural markers but makes it possible to achieve stable performance, as in the technology based on artificial markers, is a method of using a 3D LiDAR scanner. The 3D LiDAR scanner is able to recognize objects from a long distance and extract the feature points of major natural markers in the surrounding environment using a wide viewing angle. Particularly, the 3D LiDAR scanner is an essential sensor in application fields in which severe damage can be caused by a collision or the like (e.g., fields related to unmanned vehicles), and the usage thereof is expanding. Further, due to mass production and consumption, the price is gradually falling. Accordingly, the 3D LiDAR scanner is recognized as a fundamental sensor for natural-marker-based mapping and localization technology for the vehicle navigation.

Meanwhile, the recent development in Simultaneous Localization And Mapping (SLAM) technology makes it possible to create a relatively accurate map using only a 3D LiDAR scanner. As the term ‘SLAM’ suggests, SLAM is technology for estimating positions during creation of a map and creating a map based on the estimated positions. SLAM is difficult technology because it has to satisfy both mapping performance and localization performance. However, due to the importance thereof, academic studies on SLAM have been carried out for a long time, and the performance thereof has gradually improved.

However, it is difficult to directly apply SLAM using a 3D LiDAR scanner to various application fields. This is because mapping and localization closely affect each other, and it is likely that failure in one of mapping and localization will result in failure of the other as well. In other words, unless the interdependence between mapping and localization is resolved, the problem of uncertain performance may not be solved.

In the actual application field related the vehicle navigation, technology is implemented by separating mapping and localization. That is, localization is performed based on an accurate map created using SLAM, whereby the problem of interdependence between mapping and localization is solved in many cases. This is because SLAM has a great advantage in mapping and because SLAM can be performed multiple times until SLAM succeeds when mapping is actually performed.

From the aspect of implementation of autonomous navigation, technology is focused on localization for searching for a global position on a map when an accurate map is provided through a 3D LiDAR scanner and SLAM technology. This technology aims to solve two issues: applicability in a dynamic environment, in which the positions of nearby objects frequently change, such as a warehouse, and guaranteeing real-time localization.

First, applicability in a dynamic environment relates to raising the success rate of global localization even though the main structure of a space is changed or the positions of objects are changed when mapping or localization is performed. This is regarded as a problem that can be easily solved simply by updating a map using SLAM whenever the space in which a vehicle is driving changes. However, this is not a fundamental solution, because it is uncertain whether mapping using SLAM will succeed and because additional expense is incurred whenever an map is updated.

Next, real-time localization indicates whether a 3D LiDAR scanner is capable of measuring 3D point cloud data pertaining to tens of thousands to hundreds of thousands of nearby objects and effectively applying the same to localization without computational delay. This is a very important factor in order to expand service for the vehicle navigation, because searching for an initial position over the entire space requires a high computation load as the space expands.

Accordingly, in order to provide technology for stable autonomous navigation, it is required to provide technology that enables real-time global localization using only natural markers and a 3D LiDAR scanner, even though a map is not newly updated in a dynamic environment.

### DOCUMENTS OF RELATED ART

(Patent Document 1) Korean Patent No. 10-1572851 (2015 Nov. 24).

### SUMMARY OF THE INVENTION

An object of an embodiment is to realize real-time global localization using only natural markers and a 3D LiDAR scanner even though a map is not newly created in a dynamic environment in which the positions of objects do not match previously provided map information.

A method for global localization for a dynamic environment using a 3D Light Detection And Ranging (LiDAR) scanner according to an embodiment may include generating a 2D grid map from 3D point cloud data acquired using the 3D LiDAR scanner, searching for the 2D global position of a vehicle on the 2D grid map using data acquired from the 3D LiDAR scanner, and mapping the 2D global position to a 6-degrees-of-freedom (6-DOF) position in a 3D space.

Here, generating the 2D grid map may include partitioning a 3D space, in which the 3D point cloud data is distributed, into multiple 3D unit spaces, the 3D space being defined with an X-axis, a Y-axis, and a Z-axis, calculating an occupancy probability depending on whether a point is present in multiple 3D unit spaces that are aligned in a line along the Z-axis so as to correspond to each of multiple grid cells acquired by partitioning an XY plane, and generating the 2D grid map using the occupancy probability of each of the multiple grid cells on the XY plane.

Here, calculating the occupancy probability may be configured to set the occupancy probability to ‘1.0’ when a point is present in at least one of the multiple 3D unit spaces that are aligned in a line along the Z-axis so as to correspond to the grid cell, and to set the occupancy probability to ‘0.5’ by determining the multiple 3D unit spaces to be an unknown area when none of the multiple 3D unit spaces that are aligned in a line along the Z-axis so as to correspond to the grid cell contain points.

Here, calculating the occupancy probability may be configured to calculate the occupancy probability depending on whether a point is present in multiple 3D unit spaces within a first range of the Z-axis.

Here, searching for the 2D global position may be configured to assign particle samples to the 2D grid map and to search for a sample that best matches 3D point cloud data acquired from the 3D LiDAR scanner as the current position of the vehicle.

Here, searching for the 2D global position may be configured to set areas to which samples are capable of being assigned on the 2D grid map and to assign the samples only to the set areas.

Here, searching for the 2D global position may be configured to search for a sample that best matches 3D point cloud data within a second range of the Z-axis as the current position of the vehicle.

Here, the second global position may be represented using X and Y coordinates and a yaw angle on a 2D plane, and mapping the 2D global position may be configured to set an initial 6-DOF position by incorporating the X and Y coordinates and the yaw angle, which correspond to the 2D global position, and by setting a Z coordinate, a pitch angle, and a roll angle to 0.

An apparatus for global localization for a dynamic environment using a 3D Light Detection and Ranging (LiDAR) scanner according to an embodiment may include memory in which at least one program is recorded and a processor for executing the program. The program may perform generating a 2D grid map from 3D point cloud data acquired using the 3D LiDAR scanner, searching for the 2D global position of a vehicle on the 2D grid map using data acquired from the 3D LiDAR scanner, and mapping the 2D global position to a 6-degrees-of-freedom (6-DOF) position in a 3D space.

Here, generating the 2D grid map may include partitioning a 3D space, in which the 3D point cloud data is distributed, into multiple 3D unit spaces, the 3D space being defined with an X-axis, a Y-axis, and a Z-axis, calculating an occupancy probability depending on whether a point is present in multiple 3D unit spaces that are aligned in a line along the Z-axis so as to correspond to each of multiple grid cells acquired by partitioning an XY plane, and generating the 2D grid map using the occupancy probability of each of the multiple grid cells on the XY plane.

Here, calculating the occupancy probability may be configured to set the occupancy probability to ‘1.0’ when a point is present in at least one of the multiple 3D unit spaces that are aligned in a line along the Z-axis so as to correspond to the grid cell, and to set the occupancy probability to ‘0.5’ by determining the multiple 3D unit spaces to be an unknown area when none of the multiple 3D unit spaces that are aligned in a line along the Z-axis so as to correspond to the grid cell contain points.

Here, calculating the occupancy probability may be configured to calculate the occupancy probability depending on whether a point is present in multiple 3D unit spaces within a first range of the Z-axis.

Here, searching for the 2D global position may be configured to assign particle samples to the 2D grid map and to search for a sample that best matches 3D point cloud data acquired from the 3D LiDAR scanner as the current position of the vehicle.

Here, searching for the 2D global position may be configured to set areas to which samples are capable of being assigned on the 2D grid map and to assign the samples only to the set areas.

Here, searching for the 2D global position may be configured to search for a sample that best matches 3D point cloud data within a second range of the Z-axis as the current position of the vehicle.

Here, the second global position may be represented using X and Y coordinates and a yaw angle on a 2D plane, and mapping the 2D global position may be configured to set an initial 6-DOF position by incorporating the X and Y coordinates and the yaw angle, which correspond to the 2D global position, and by setting a Z coordinate, a pitch angle, and a roll angle to 0.

A method for global localization for a dynamic environment using a 3D Light Detection and Ranging (LiDAR) scanner according to an embodiment may include partitioning a 3D space in which 3D point cloud data acquired using the 3D LiDAR scanner is distributed into multiple 3D unit spaces, the 3D space being defined with an X-axis, a Y-axis and a Z-axis, calculating an occupancy probability depending on whether a point is present in multiple 3D unit spaces that are aligned in a line along the Z-axis so as to correspond to each of multiple grid cells acquired by partitioning an XY plane, generating a 2D grid map using the occupancy probability of each of the multiple grid cells on the XY plane, searching for the 2D global position of a vehicle on the 2D grid map using data acquired from the 3D LiDAR scanner, and mapping the 2D global position to a 6-degrees-of-freedom (6-DOF) position in the 3D space. The 2D global position may be represented using X and Y coordinates and a yaw angle on a 2D plane, and mapping the 2D global position may be configured to set an initial 6-DOF position by incorporating the X and Y coordinates and the yaw angle, corresponding to the 2D global position, and by setting a Z coordinate, a pitch angle, and a roll angle to 0.

Here, calculating the occupancy probability may be configured to calculate the occupancy probability depending on whether a point is present in multiple 3D unit spaces within a first range of the Z-axis.

Here, searching for the 2D global position may be configured to assign particle samples to the 2D grid map, search for a sample that best matches 3D point cloud data acquired from the 3D LiDAR scanner as the current position of the vehicle, set areas to which samples are capable of being assigned on the 2D grid map, and assign the samples only to the set areas.

Here, searching for the 2D global position may be configured to search for a sample that best matches 3D point cloud data within a second range of the Z axis as the current position of the vehicle.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a schematic block diagram of a global localization system for a dynamic environment using a 3D LiDAR scanner according to an embodiment;

FIG. 2 is a flowchart for explaining a global localization method for a dynamic environment using a 3D LiDAR scanner according to an embodiment;

FIG. 3 is a view for explaining generation of a 2D grid map according to an embodiment;

FIG. 4 is an exemplary view of 3D point cloud data according to an embodiment;

FIG. 5 is an exemplary view of a 2D grid map extracted from the 3D point cloud data illustrated in FIG. 4;

FIG. 6 is an exemplary view illustrating setting of an area to which samples of a particle filter are to be assigned according to an embodiment;

FIG. 7 is an exemplary view illustrating assignment of samples of a particle filter to the set area illustrated in FIG. 6;

FIG. 8 is an exemplary view illustrating condensation of information scanned by a 3D LiDAR scanner for particle-filter-based matching according to an embodiment;

FIG. 9 is an exemplary view illustrating the result of initial global localization through particle-filter-based matching according to an embodiment;

FIG. 10 is an exemplary view illustrating 6-DOF localization based on an initial 2D global position and a 3D point cloud according to an embodiment; and

FIG. 11 is a view illustrating a computer system configuration according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

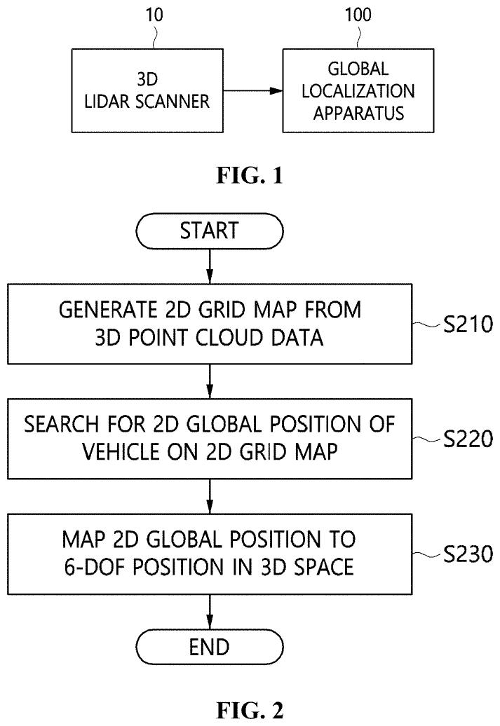

Hereinafter, a global localization apparatus and method for a dynamic environment using a 3D LiDAR scanner according to an embodiment will be described in detail with reference to FIGS. 1 to 11.

FIG. 1 is a schematic block diagram of a global localization system for a dynamic environment using a 3D LiDAR scanner according to an embodiment.

Referring to FIG. 1, the global localization system for a dynamic environment using a 3D LiDAR scanner may include a 3D LiDAR scanner 10 and a global localization apparatus 100 (hereinafter, referred to as an ‘apparatus’).

The 3D LiDAR scanner 10 and the apparatus 100 may be physically separated from each other, or the 3D LiDAR scanner 10 may be mounted on the apparatus 100.

The global localization apparatus 100 is mounted on a vehicle, such as a robot, thereby estimating the current 6-DOF position of the vehicle using the 3D LiDAR scanner 10 and creating a 3D point cloud configuring the space in the form of a map based on the estimated position.

The 3D LiDAR scanner 10 is capable of measuring the position of an object in the space from a long distance using the wide viewing angle thereof, and exhibits excellent performance when it estimates and tracks the position thereof in the limited area of the space, even though the positions of some surrounding objects are changed.

However, it is difficult to detect a geometrical relationship between adjacent points based only on the 3D point cloud data generated using the 3D LiDAR scanner 10. Also, the greater the size and complexity of the space, the greater the amount of point cloud data required for localization. Accordingly, a high computation load is required in order to track the current position over the entire area, rather than in a limited area, which makes it difficult to realize real-time localization.

Localization technology based on a 3D LiDAR scanner is required to guarantee real-time characteristics while ensuring applicability in a dynamic environment. To this end, technology capable of estimating the initial global position of a vehicle in real time and tracking the position based thereon even in a dynamic environment is required.

Accordingly, the apparatus 100 according to an embodiment is designed to extract a 2D grid map from 3D point cloud data such that spatial information is condensed into the 2D grid map, to recognize a global position in the 2D domain in real time, and to continuously estimate a 6-DOF position using a 3D-point-cloud-matching method. That is, the 6-DOF position is initialized based on the estimated global position, and the position is continuously tracked by matching the same with a point cloud acquired from the 3D LiDAR scanner.

Through the above-described embodiment, real-time global localization may be realized using a 2D grid map and a portion of data acquired from the 3D LiDAR scanner, and accurate position tracking may be realized even in a changing environment by matching the position with a 3D point cloud.

FIG. 2 is a flowchart for explaining a global localization method for a dynamic environment using a 3D LiDAR scanner according to an embodiment.

Referring to FIG. 2, the global localization method for a dynamic environment using a 3D LiDAR scanner according to an embodiment may include generating a 2D grid map from 3D point cloud data pertaining to a position estimated using the 3D LiDAR scanner at step S210, searching for the 2D global position of a vehicle on the 2D grid map using 3D point cloud data acquired in real time from the 3D LiDAR scanner at step S220, and mapping the 2D global position to a 6-DOF position in the 3D space at step S230.

Here, at the step of generating the 2D grid map (S210), the 3D point cloud data may be the data that is generated by correcting the position acquired through SLAM technology.

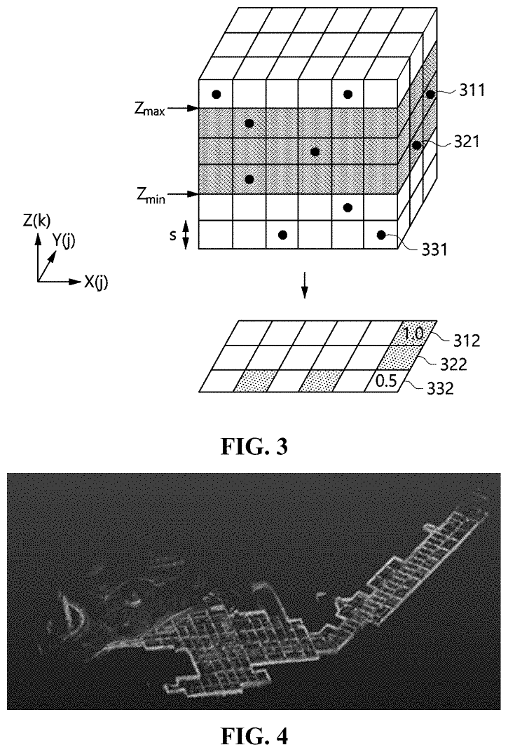

Here, at the step of generating the 2D grid map (S210), the vertical geometric information of the 3D space may be condensed into the 2D grid map. This will be described with reference to FIGS. 3 to 5.

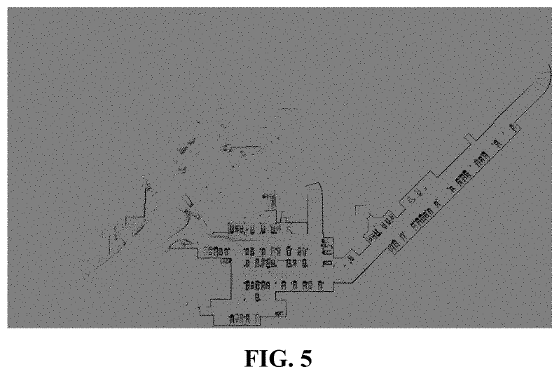

FIG. 3 is a view for explaining generation of a 2D grid map according to an embodiment, FIG. 4 is an exemplary view of 3D point cloud data according to an embodiment, and FIG. 5 is an exemplary view of a 2D grid map extracted from the 3D point cloud data illustrated in FIG. 4.

Referring to FIG. 3, the 3D space in which 3D point cloud data, the position of which estimated, is distributed is defined with an X-axis, a Y-axis, and a Z-axis, and may be evenly partitioned into multiple 3D unit spaces. Here, each of the unit spaces may be a cube, the length of each edge of which is ‘s’.

Then, an occupancy probability is calculated depending on whether a point is present in the multiple 3D unit spaces that are aligned in a line along the Z-axis so as to correspond to each of multiple grid cells acquired by partitioning the XY plane.

Here, when a point is present in at least one of the multiple 3D unit spaces that are aligned in a line along the Z-axis so as to correspond to the grid cell, the space is determined to be an area in which an object is present, and the occupancy probability is set to ‘1.0’. Conversely, when none of the multiple 3D unit spaces that are aligned in a line along the Z-axis so as to correspond to the grid cell contain points, the space is determined to be an unknown area, and the occupancy probability is set to ‘0.5’. Accordingly, the vertical geometric information of the 3D space is condensed into the 2D grid map.

Here, calculating the occupancy probability is configured to calculate the occupancy probability depending on whether a point is present in the multiple 3D unit spaces within a first range of the Z-axis.

This is because it is necessary to reduce the amount of 3D point cloud data to be used for a matching process in order to guarantee real-time characteristics, although it is best to use all 3D point cloud data acquired from the 3D LiDAR scanner. To this end, Zₘᵢₙ and Zₘₐₓ, which are the minimum height and the maximum height on the Z-axis, are set, and only the point cloud data in the 3D unit spaces within the first range between Zₘᵢₙ and Zₘₐₓis incorporated into the 2D grid map.

Accordingly, as illustrated in FIG. 3, the points 311 and 321 falling within the first range between Zₘᵢₙ and Zₘₐₓ are incorporated, and the occupancy probabilities of the respective 2D grid cells 312 and 322 corresponding thereto are set to ‘1.0’. Conversely, the point 331, which is not included in the first range between Zₘᵢₙ and Zₘₐₓ, is not incorporated, and the occupancy probability of the 2D grid cell 332 corresponding thereto is set to ‘0.5’.

As described above, the 2D grid map may be generated using occupancy probabilities corresponding to the multiple grid cells on the XY plane. For example, the 2D grid map illustrated in FIG. 5 may be generated from the 3D point cloud data illustrated in FIG. 4.

Meanwhile, at the step of searching for the 2D global position (S220) illustrated in FIG. 2, a particle filter, which is the most representative sampling method, may be used.

That is, only a part of the 3D point cloud data measured in real time by the 3D LiDAR scanner is selected, and the global position on the 2D grid map is estimated through sampling matching based on a particle filter.

Here, the particle filter is implemented to assign particle samples corresponding to the candidate positions of a vehicle to the 2D grid map and select the sample that best matches the 3D point cloud data acquired in real time from the 3D LiDAR scanner as the current position of the vehicle.

Here, the larger the space, the greater the number of samples required to be assigned. Further, because the number of structures having similar contours increases as the space is expanded, the particle filter may fail in accurate matching.

Accordingly, searching for the 2D global position at step S220 according to an embodiment may be configured to set, in advance, areas to which samples can be assigned on the 2D grid map and to assign the samples only to the areas set in advance.

That is, only some areas in which a vehicle can be present are previously designated as areas to which samples can be assigned on the 2D grid map, whereby the number of samples to be assigned to the space may be reduced.

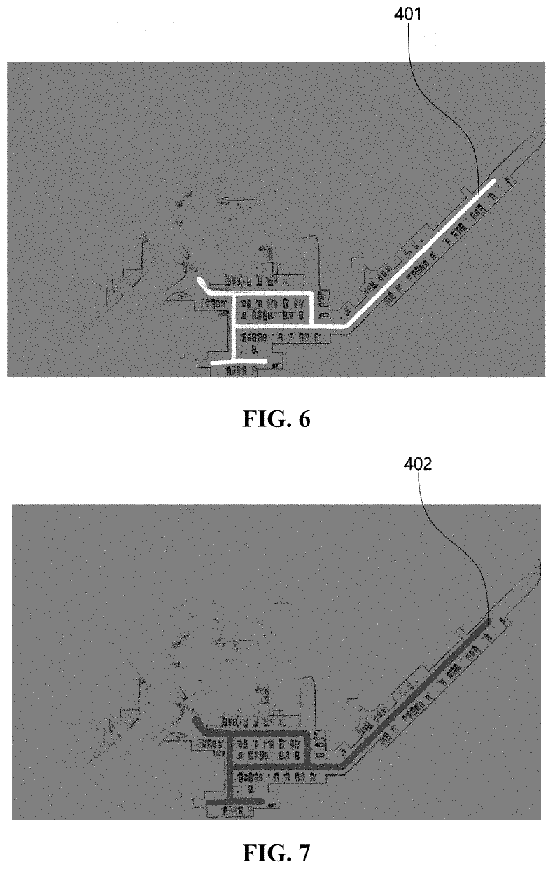

FIG. 6 is an exemplary view illustrating setting of areas to which samples of a particle filter are to be assigned according to an embodiment.

Referring to FIG. 6, in order to use a particle filter, the occupancy probability of a grid cell for the area 401 to which a sample can be assigned is set to ‘0’. Accordingly, the number of samples to be assigned may be reduced or adjusted, which is very important to improve real-time performance in initial global localization.

FIG. 7 is an exemplary view illustrating assignment of a sample of a particle filter to the set area illustrated in FIG. 6.

FIG. 7 shows that samples are actually randomly assigned (402) only to the area that is set as the area to which the samples of the particle filter are to be assigned.

Meanwhile, searching for the 2D global position at step S220 may be configured such that the sample having the highest degree of matching between the real-time 3D point cloud data of the LiDAR scanner and the 2D grid map is searched for as the current position of the vehicle.

That is, in order to search for the global position of the vehicle using the samples of the particle filter, it is necessary to check the outline thereof on the 2D grid map and to match the current point cloud data acquired using the 3D LiDAR scanner 10 with the 2D grid map.

Here, when the 2D grid map is not extracted from all 3D point cloud data, as described above, that is, when the 2D grid map is extracted from 3D point cloud data within the first range, as illustrated in FIG. 3, it is necessary to adjust the current 3D point cloud data measured by the 3D LiDAR scanner so as to match the first range.

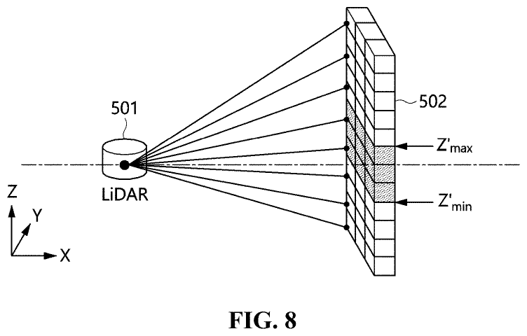

FIG. 8 is an exemplary view illustrating condensation of information scanned by a 3D LiDAR scanner for particle-filter-based matching according to an embodiment.

Referring to FIG. 8, the point cloud data 502 measured by and acquired from the 3D LiDAR scanner 501 is condensed depending on the height value thereof. That is, when the Z coordinate value of the current position of the 3D LiDAR scanner 501 is ‘0’, only point cloud data included in a second range between the minimum height value Z′ₘᵢₙ and the maximum height value Z′ₘₐₓ is used for particle-filter-based matching.

Here, the second range may be set using the parameters of the first range, which were used when the 2D grid map was extracted from the existing 3D point cloud, without change, or may be set differently from the first range by taking into consideration the difference between the height used for construction of the 3D point cloud and the height used for localization. Accordingly, the amount of information acquired from the 3D LiDAR scanner, which is to be used for particle-filter-based matching, is reduced, and the complexity of the computation, which is performed for the matching process used for localization, may also be reduced.

Meanwhile, at the step of searching for the 2D global position (S220), the 2D global position may be represented using the X and Y coordinates and the yaw angle thereof in the 2D plane.

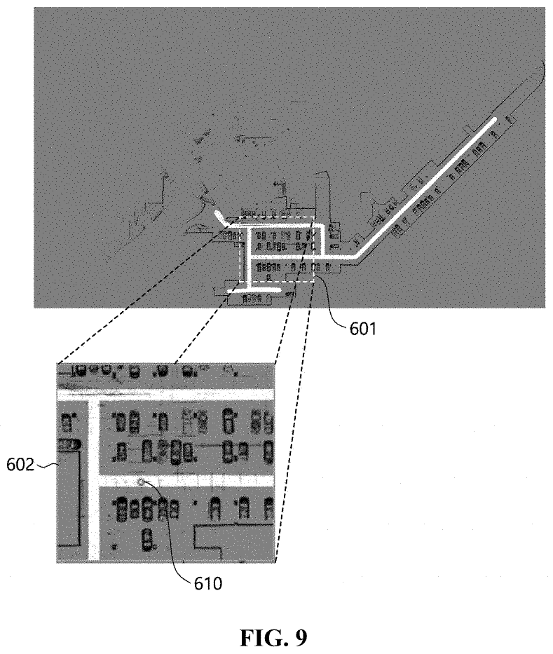

FIG. 9 is an exemplary view illustrating the result of initial global localization through particle-filter-based matching according to an embodiment.

Referring to FIG. 9, the X and Y coordinates and the yaw angle on the 2D plane may be searched for as the initial global position 610 through the particle filter on the 2D grid maps 601 and 602.

Meanwhile, mapping the 2D global position at step S230 is configured such that the X and Y coordinates and the yaw angle, which represent the 2D global position, are incorporated, and the Z coordinate, the pitch angle, and the roll angle are set to ‘0’, whereby the initial 6-DOF position is set.

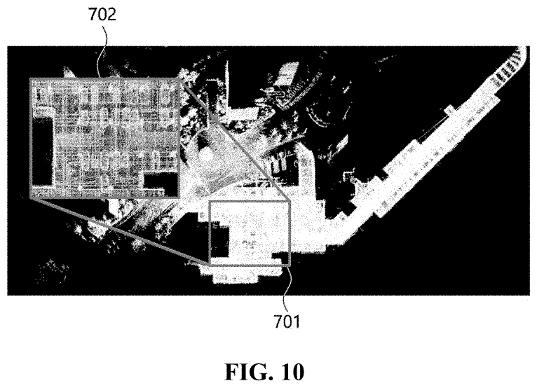

FIG. 10 is an exemplary view illustrating 6-DOF localization based on an initial 2D global position and a 3D point cloud according to an embodiment.

Referring to FIG. 10, the 6-DOF position in the 3D domain is estimated through 3D-point-cloud-matching based on the initial global position in the 2D domain. That is, through the 2D grid map and the particle filter, the initial global position information in the 2D domain is reflected in the 6-DOF localization based on a 3D point cloud.

Here, the 6-DOF position in the 3D domain may be configured with orthogonal coordinates including X, Y and Z coordinates, and spherical coordinates, including a yaw angle, a pitch angle, and a roll angle.

According to an embodiment, the X and Y coordinates and the yaw angle, which correspond to the 2D global position found at step S220, are respectively taken as the X coordinate, the Y coordinate, and the yaw angle of the 6-DOF position in the 3D domain, and the Z coordinate, the pitch angle, and the roll angle, which are the remaining components of the 6-DOF position in the 3D domain, are set to ‘0’.

As described above, the 6-DOF position is initialized based on the estimated global position, and the position of the vehicle may be continuously tracked by matching the same with the point cloud acquired from the 3D LiDAR scanner.

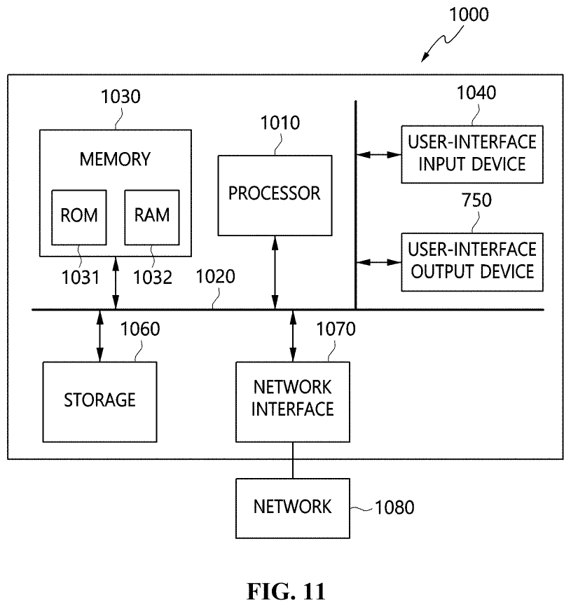

FIG. 11 is a view illustrating a computer system configuration according to an embodiment.

The global localization apparatus for a dynamic environment using a 3D LiDAR scanner according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

According to an embodiment, real-time global localization may be realized using only natural markers and a 3D LiDAR scanner, even though a map is not newly updated in a dynamic environment in which the positions of objects do not match previously provided map information.

That is, when global localization technology according to an embodiment is used, vehicles may estimate the positions thereof in any place without information about special artificial markers for localization.

Also, through an embodiment, applicability in a dynamic environment and real-time localization may be ensured when localization of vehicles is performed. This may be useful to implement various navigation services for vehicles even in application fields in which it is impossible to provide driving technology due to the absence of stable technology for localization of vehicles.

Although embodiments of the present invention have been described with reference to the accompanying drawings, those skilled in the art will appreciate that the present invention may be practiced in other specific forms without changing the technical spirit or essential features of the present invention. Therefore, the embodiments described above are illustrative in all aspects and should not be understood as limiting the present invention.

What is claimed is:

1. A method for global localization for a dynamic environment using a 3D Light Detection And Ranging (LiDAR) scanner, comprising:
generating a 2D grid map from 3D point cloud data acquired using the 3D LiDAR scanner;
searching for a 2D global position of a vehicle on the 2D grid map using data acquired from the 3D LiDAR scanner; and
mapping the 2D global position to a 6-degrees-of-freedom (6-DOF) position in a 3D space.

2. The method of claim 1, wherein generating the 2D grid map comprises:
partitioning a 3D space, in which the 3D point cloud data is distributed, into multiple 3D unit spaces, the 3D space being defined with an X-axis, a Y-axis, and a Z-axis;
calculating an occupancy probability depending on whether a point is present in multiple 3D unit spaces that are aligned in a line along the Z-axis so as to correspond to each of multiple grid cells acquired by partitioning an XY plane; and
generating the 2D grid map using the occupancy probability of each of the multiple grid cells on the XY plane.

3. The method of claim 2, wherein calculating the occupancy probability is configured to:
set the occupancy probability to ‘1.0’ when a point is present in at least one of the multiple 3D unit spaces that are aligned in a line along the Z-axis so as to correspond to the grid cell, and
set the occupancy probability to ‘0.5’ by determining the multiple 3D unit spaces to be an unknown area when none of the multiple 3D unit spaces that are aligned in a line along the Z-axis so as to correspond to the grid cell contain points.

4. The method of claim 2, wherein calculating the occupancy probability is configured to calculate the occupancy probability depending on whether a point is present in multiple 3D unit spaces within a first range of the Z-axis.

5. The method of claim 1, wherein searching for the 2D global position is configured to assign particle samples to the 2D grid map and search for a sample that best matches 3D point cloud data acquired from the 3D LiDAR scanner as a current position of the vehicle.

6. The method of claim 5, wherein searching for the 2D global position is configured to set areas to which samples are capable of being assigned on the 2D grid map and to assign the samples only to the set areas.

7. The method of claim 5, wherein searching for the 2D global position is configured to search for a sample that best matches 3D point cloud data within a second range of a Z-axis as the current position of the vehicle.

8. The method of claim 1, wherein:
the second global position is represented using X and Y coordinates and a yaw angle on a 2D plane, and
mapping the 2D global position is configured to set an initial 6-DOF position by incorporating the X and Y coordinates and the yaw angle, which correspond to the 2D global position, and by setting a Z coordinate, a pitch angle, and a roll angle to 0.

9. An apparatus for global localization for a dynamic environment using a 3D Light Detection and Ranging (LiDAR) scanner, comprising:
memory in which at least one program is recorded; and
a processor for executing the program,
wherein the program performs
generating a 2D grid map from 3D point cloud data acquired using the 3D LiDAR scanner;
searching for a 2D global position of a vehicle on the 2D grid map using data acquired from the 3D LiDAR scanner; and
mapping the 2D global position to a 6-degrees-of-freedom (6-DOF) position in a 3D space.

10. The apparatus of claim 9, wherein generating the 2D grid map comprises:
partitioning a 3D space, in which the 3D point cloud data is distributed, into multiple 3D unit spaces, the 3D space being defined with an X-axis, a Y-axis, and a Z-axis;
calculating an occupancy probability depending on whether a point is present in multiple 3D unit spaces that are aligned in a line along the Z-axis so as to correspond to each of multiple grid cells acquired by partitioning an XY plane; and
generating the 2D grid map using the occupancy probability of each of the multiple grid cells on the XY plane.

11. The apparatus of claim 10, wherein calculating the occupancy probability is configured to:
set the occupancy probability to ‘1.0’ when a point is present in at least one of the multiple 3D unit spaces that are aligned in a line along the Z-axis so as to correspond to the grid cell, and
set the occupancy probability to ‘0.5’ by determining the multiple 3D unit spaces to be an unknown area when none of the multiple 3D unit spaces that are aligned in a line along the Z-axis so as to correspond to the grid cell contain points.

12. The apparatus of claim 10, wherein calculating the occupancy probability is configured to calculate the occupancy probability depending on whether a point is present in multiple 3D unit spaces within a first range of the Z-axis.

13. The apparatus of claim 9, wherein searching for the 2D global position is configured to assign particle samples to the 2D grid map and search for a sample that best matches 3D point cloud data acquired from the 3D LiDAR scanner as a current position of the vehicle.

14. The apparatus of claim 13, wherein searching for the 2D global position is configured to set areas to which samples are capable of being assigned on the 2D grid map and to assign the samples only to the set areas.

15. The apparatus of claim 13, wherein searching for the 2D global position is configured to search for a sample that best matches 3D point cloud data within a second range of a Z-axis as the current position of the vehicle.

16. The apparatus of claim 9, wherein:
the second global position is represented using X and Y coordinates and a yaw angle on a 2D plane, and
mapping the 2D global position is configured to set an initial 6-DOF position by incorporating the X and Y coordinates and the yaw angle, which correspond to the 2D global position, and by setting a Z coordinate, a pitch angle, and a roll angle to 0.

17. A method for global localization for a dynamic environment using a 3D Light Detection and Ranging (LiDAR) scanner, comprising:
partitioning a 3D space in which 3D point cloud data acquired using the 3D LiDAR scanner is distributed into multiple 3D unit spaces, the 3D space being defined with an X-axis, a Y-axis and a Z-axis;
calculating an occupancy probability depending on whether a point is present in multiple 3D unit spaces that are aligned in a line along the Z-axis so as to correspond to each of multiple grid cells acquired by partitioning an XY plane;
generating a 2D grid map using the occupancy probability of each of the multiple grid cells on the XY plane;
searching for a 2D global position of a vehicle on the 2D grid map using data acquired from the 3D LiDAR scanner; and
mapping the 2D global position to a 6-degrees-of-freedom (6-DOF) position in the 3D space,
wherein
the 2D global position is represented using X and Y coordinates and a yaw angle on a 2D plane, and
mapping the 2D global position is configured to set an initial 6-DOF position by incorporating the X and Y coordinates and the yaw angle, corresponding to the 2D global position, and by setting a Z coordinate, a pitch angle, and a roll angle to 0.

18. The method of claim 17, wherein calculating the occupancy probability is configured to calculate the occupancy probability depending on whether a point is present in multiple 3D unit spaces within a first range of the Z-axis.

19. The method of claim 18, wherein searching for the 2D global position is configured to assign particle samples to the 2D grid map, search for a sample that best matches 3D point cloud data acquired from the 3D LiDAR scanner as a current position of the vehicle, set areas to which samples are capable of being assigned on the 2D grid map, and assign the samples only to the set areas.

20. The method of claim 19, wherein searching for the 2D global position is configured to search for a sample that best matches 3D point cloud data within a second range of the Z axis as the current position of the vehicle.
